(19) United States
(12) Patent Application Publication
(10) Pub. No.: US 2003/0125421 A1
(43) Pub. Date: Jul. 3, 2003

(54) Aqueous dispersions of fluoropolymers

(76) Inventors: Hermann Bladel, Mengerskirchen-Winkels (DE); Klaus Hintzer, Kastl (DE); Gernot Lohr, Burgkirchen (DE); Werner Schwertfeger, Altotting (DE); Reinhard A. Sulzbach, Burghausen (DE)

Correspondence Address: Office of Intellectual Property Counsel, 3M Innovative Properties Company, PO Box 33427, St. Paul, MN, 55133-3427, US

(21) Appl. No.: 10/022,561

(22) Filed: Dec. 13, 2001

Related U.S. Application Data
(63) Continuation-in-part of application No. 09/857,081, filed on Aug. 3, 2001.

(51) Int. Cl. C08L 1/00

(52) U.S. Cl. 523/310

(57) ABSTRACT

Fluorine-containing emulsifiers can be removed from fluoropolymer dispersions by adding to the dispersion a non ionic emulsifier, removing the fluorine-containing emulsifier by contact with an anion exchanger and separating the dispersion from the anion exchanger. The resulting dispersions can be upconcentrated and used for coating applications, such as fabric coating and metal coating.

This application is a continuation-in-part of U.S. application Ser. No. 09/857,081 filed May 31, 2001.

### FIELD OF THE INVENTION

The invention relates to aqueous dispersions of fluoropolymers that are essentially free of fluorine-containing emulsifiers, a process for making such dispersions and their use.

### BACKGROUND

Polyfluoroethylene-dispersions find broad application in the coating industry due to the unique performance of the coatings e.g. antistickiness, good weatherability, and noninflammability. They are mainly used for coating kitchenware, such as cookware and bakeware, chemical apparatures and glass fabrics. In many such applications, the dispersions are applied at relatively high solid contents, e.g., up to 70 weight-%. These concentrated dispersions are prevailingly colloid chemically stabilized by nonionic emulsifiers such as alkyl aryl polyethoxy alcohols and alkyl polyethoxy alcohols.

There are basically two different polymerization processes used for making fluoropolymers, namely suspension polymerization and emulsion polymerization. Suspension polymerization leads to a granulate polymer. Emulsion polymerization leads to an aqueous colloidal dispersion of the polymer. This invention concerns the emulsion polymerization, the so-obtained dispersions and their use.

The manufacturing of emulsion polymerized dispersions involves basically two processing steps, aqueous emulsion polymerization and upconcentration.

The aqueous emulsion polymerization process can be used to produce (a) non-melt processible homopolymers, e. g. PTFE; (b) “modified” PTFE polymers, e. g. a polymer containing more than about 99 mol % of tetrafluoroethylene (TFE) and only such a small amount of comonomer(s) as to render the product still not processible from the melt; (c) low molecular weight “micro powder” dispersions which are processible from the melt; and (d) copolymers, such as fluorothermoplasts and fluoroelastomers. Fluorothermoplasts include copolymers consisting predominantly of TFE and an amount of one or more comonomer(s), e. g. 1 to 50, preferably 1 to 10 mol %, so that the product is processible from the melt. Fluoroelastomers are copolymers of the same monomers used to make fluorothermoplastics. They differ from fluorothermoplastics in that TFE is not always used and in that they are amorphous.

Common fluoromonomers used in the manufacture of fluoropolymers in addition to TFE include vinylidene fluoride (VDF), trifluoroethylene, other fluorinated olefins, such as chloro-trifluoroethylene (CTFE), especially perfluorinated olefins of 2 to 8 carbon atoms, e. g., hexafluoropropene (HFP), fluorinated ethers, especially perfluorinated vinyl-alkylethers with alkyls of 1 to 6 carbon atoms; e. g. perfluoro-(n-propyl-vinyl)-ether (PPVE). VDF may also be polymerized as a homopolymer or with monomers other than TFE. Other useful comonomers include nonfluorinated olefins, e. g. ethylene and propylene. Dispersions of polymers, which may be melt-processible or not, usually have solids content of 15 to 30 weight-%. To obtain the above-mentioned high solids content for application as a coating, and for benefits in storing and transportation, the solids content is preferably increased by upconcentration. Practiced, for example, are the thermal upconcentration as described in U.S. Pat. No. 3,316,201, the decantation (U.S. Pat. No. 3,037,953) and the ultrafiltration (U.S. Pat. No. 4,369,266).

The emulsion polymerization process is commonly carried out within a pressure range of 5 to 30 bars and within a temperature range of 5 to 100° C. as described e.g. in EP-B 30 663. The polymerization process to make PTFE-dispersions is essentially the same as the known process to make fine resin powders, so called paste ware (U.S. Pat. No. 3,142,665). The polymerization process to produce copolymers such as fluorothermoplast dispersions is the same process as to produce these materials applied as melt pellets. Fluoroelastomers may also be made using this process.

All these emulsion polymerizations have in common that they need an emulsifier which does not interfere with the polymerization, e.g. by a chain transfer reaction. These emulsifiers are called non-telogenic emulsifiers (U.S. Pat. No. 2,559,752). Predominantly, perfluorooctanoic (PFOA) acids (such as n-PFOA, CAS No. 335-67-1) are used as ammonium and/or alkali salts. When “PFOA” is used in the following text, it is to be understood that other fluorinated emulsifiers are included. The content of this emulsifier usually ranges from 0.02 to 1 weight-% with respect to the polymer. Commercially available PFOA emulsifiers are commonly mixtures of various carbon chain lengths including perfluorobutanoic acids to perfluorododecanoic acids, with the majority of the content being perfluorooctanoic acids.

Occasionally other fluoroemulsifiers are used. For example EP-A 822 175 describes the use of salts of CH₂-containing fluorocarboxylic acids for the emulsion polymerization of TFE. WO-A 97/08214 discloses the use of 2-perfluorohexyl ethanesulfonic acid or salts for TFE polymerization.

Still further fluorinated emulsifiers are described in U.S. Pat. No. 2,559,752. However, these emulsifiers are not commonly used because of their low volatility. These chemicals may result in discoloration of the end products at high processing temperatures.

One of the biggest advantages of PFOA is its high volatility. PFOA is a very powerful emulsifier and, due to its inertness during the polymerization, is very useful. However, it has been reported that certain perfluorooctyl-containing compounds, such as PFOA, may tend to have low bioelimination rates in living organisms as well as persistence in the environment. Thus, it is desirable to find an effective method for removing such materials from commercial products.

Processes are known for the removal of PFOA from waste gases (EP-B 731 081) and from waste-water (U.S. Pat. No. 4,282,162 and German Patent Applications 198 24 614.5 and 198 24 615.3 filed Jun. 2, 1998).

In the above-mentioned upconcentration technologies, a significant portion of the PFOA may stay with the polymer dispersion, even when using the ultrafiltration and the decantation processes and employing a hundred-fold excess of the nonionic emulsifier.

For instance when the ultrafiltration process as described in U.S. Pat. No. 4,369,266 is used, about 30% of the original PFOA content stays with the resulting commercial dispersions. In special cases the remaining PFOA content can be reduced to less than 10% but the process is generally not economical because to achieve such a reduction one has to constantly replenish the water and a nonionic emulsifier to the dispersion to be upconcentrated. This makes the run times unacceptably long.

During subsequent use of these dispersions, the PFOA may be released to the environment, e.g. via the unavoidable waste-water for cleaning the equipment and via an aerosol into the atmosphere. The latter release is enhanced at the making of the coatings since PFOA and its ammonium salt are very volatile.

### SUMMARY

The present invention provides a high solid dispersions of fluoropolymer that is essentially free of PFOA. In this invention, “essentially free” means a content of less than 100 ppm, preferably less than 50 ppm, especially less than 25 ppm and in particular less than 5 ppm. These values are based on the entire dispersion of the fluoropolymer, and not just the solids content (i.e., the fluoropolymer itself). This is achieved by removal of fluorinated emulsifiers, e.g. PFOA, from fluoropolymer dispersions, such as PTFE, fluorothermoplast or fluoroelastomer dispersions. The fluorinated emulsifiers are removed via anion exchange, namely by adding a nonionic emulsifier to the fluoropolymer dispersion and contacting this stabilized dispersion with a basic anion exchanger. This process works without jamming or clogging the ion exchange bed by coagulated latex particles. The resulting dispersion may optionally be upconcentrated.

Fluoropolymer dispersions useful in this invention include dispersions of homopolymers and copolymers of one or more fluorinated monomers, such as TFE, VDF or CTFE or other fluorinated olefins of 2 to 8 carbon atoms, trifluoroethylene, perfluorinated olefins of 2 to 8 carbon atoms, e.g., HFP, fluorinated ethers, especially perfluorinated vinyl-alkyl ethers with alkyls of 1 to 6 carbon atoms, such as perfluoro-(n-propyl-vinyl) ether and perfluoro-(methyl-vinyl) ether. Useful comonomers also include non-fluorinated olefins, such as ethylene or propylene. This invention also includes such dispersions whether the resulting fluoropolymer is melt-processible or not.

### DETAILED DESCRIPTION

The latex particles of the dispersions usually have a submicroscopic diameter of less than 400 nm and preferably between 40-400 nm. Smaller particle sizes may be obtained by so-called “micro-emulsion polymerization.” The latex particles are anionically stabilized in the sense of colloid chemistry. The anionic stabilization is provided by anionic endgroups, mostly COOH-groups, and by the anionic emulsifier such as PFOA. Such anionically stabilized dispersions coagulate rapidly in an anion exchange bed and thus jam the ion exchange bed. The reason for that is the break down of the electrical double layer at the ion exchange sites. Therefore the treatment of an anionically stabilized dispersion with an anion exchanger is not considered to be technically feasible, in particular for higher concentrations.

The impairing or clogging of an ion exchange bed has already been observed at concentrations 1000 times lower than those of the raw polymer dispersions, that is the dispersion after polymerization.

Helpful for the choice of a useful ion exchanger is the observation that the pKa value of the acid corresponding to the counterion of the anion exchanger has to be higher than the pKa value of the anionic endgroups of the polymer. Preferably, the anion exchanger has a counterion corresponding to an acid with a pKa value of at least 3.

In contrast, coagulation is observed on the long term if the anion exchanger is in the SO₄⁻² or Cl⁻ form even with dispersions of copolymers of TFE with HFP, called “FEP”, and of TFE with PPVE, called “PFA”. These copolymers both have strongly acidic endgroups. The formation of such endgroups is explained in “Modern Fluoropolymers”, John Scheirs (Editor), John Wiley & Sons, Chichester (1997), pages 227 to 288, 244. The jamming or clogging of ion exchange beds when processing TFE-ethylene or vinylidene fluoride copolymer dispersions occurs under such conditions almost instantly.

Therefore, at the outset, the anion exchange is performed in an essentially basic environment. Preferably, the ion exchange resin is transformed to the OH⁻ form, but anions like fluoride or oxalate corresponding to weak acids can also be used. These anions are generally present in the dispersion from the polymerization recipe.

The specific basicity of the anion exchanger used is not very critical. Strongly basic resins are preferred due to the observed higher efficiency in removing PFOA. The effective removal of PFOA from the dispersions depends on the ion exchange conditions. Weakly basic ion exchange resins show earlier PFOA break through. The same is true for higher flow rates.

The flow rate is not very critical, standard flow rates can be used. The flow can be upward or downward.

The ion exchange process can also be carried out as a batch process by mildly stirring the dispersion with the ion exchange resin in a vessel. After this treatment the dispersion is isolated by filtration. Use of this invention will minimize coagulation during a batch process.

Non ionic emulsifiers are described in detail in “Nonionic Surfactants edited by M. J. Schick, Marcel Dekker, Inc., New York 1967”.

The choice of the nonionic emulsifier is not critical either. Alkyl aryl polyethoxy alcohols, alkyl polyethoxy alcohols, or any other non ionic emulsifier can be used. This is a big advantage since the removal of PFOA from commercial dispersions leaves the formulation of the applied dispersions essentially unchanged.

No differences could be observed using non ionic surfactants such as alkyl aryl polyethoxy alcohol type, e.g., Triton™ X100, or alkyl polyethoxy alcohol type, e.g., GENAPOL™ X 080, with respect to effectiveness of the PFOA removal, flow rates, or jamming of the ion exchanger bed.

The removal of PFOA is preferably carried out with raw dispersions from the polymerization. Such dispersions generally have a solid content of 10 to 70, preferably 15 to 30, weight-% to which is added sufficient non-ionic emulsifier to provide dispersion stability during subsequent processing, such as upconcentration. A sufficient quantity of non-ionic emulsifier generally means from 0.5 to 15 weight-% and preferably from 1 to 12, more preferably from 1 to 5 weight-%. Most preferably the quantity of non-ionic emulsifier is from 3 to 10% by weight. These percentages are based upon the solids content of the dispersion. After removal of the PFOA, the dispersions may be upconcentrated using conventional procedures, such as ultrafiltration or thermal upconcentration. It is advantageous that the concentration of the non-ionic emulsifier in the final product is not much higher than in comparable commercial products. The absence of PFOA in these processes does not negatively affect the upconcentration. That is, no more coagulum is formed than in presence of PFOA at the thermal upconcentration and the ultrafiltration.

The removal of PFOA via anion exchange can also be carried out with already upconcentrated dispersions with a solids content of up to 70 weight-%. However, due to the higher viscosity and density of such dispersions the process is technically more cumbersome. In this case the ion exchange is preferably driven upstream to avoid difficulties due to the floating of the ion exchange bed. Mostly the high viscosity does not permit high flow rates. For such high solid dispersions the batch process appears to be more advantageous.

The removal of PFOA is carried out by adding typically 1 to 5 weight-% nonionic emulsifier to the dispersion under mild agitation conditions and passing the resulting combination over the anion exchanger. The anion exchanger may be preconditioned with a solution of nonionic emulsifier as used with the dispersion to be exchanged. The anion exchange resin is preferably brought into the OH⁻ form. This is accomplished by contacting the anion exchange resin with a NaOH solution.

Usually dispersions are used for the ion exchange process without adjusting the pH value but the pH value may be increased to enhance the colloidal stability of the dispersion by adding a base like aqueous ammonia or sodium hydroxide solution. A pH value in the range of 7 to 9 is sufficient. The increased pH value does not affect very much the efficiency of the removal of PFOA. This is believed to be due to the fact that PFOA is not only exchanged but also strongly absorbed on the ion exchange resin.

The anion exchange process of the invention can also be successfully used for the removal of any other anionic emulsifier used in any polymerization process without jamming the ion exchange bed.

This process may also be used for any fluoropolymer raw dispersions, such as, for example, dispersions of PFA, FEP, THV (THV is a terpolymer of TFE, HFP VDF), ET (ET is a copolymer of TFE and ethylene), TFE/P (a copolymer of TFE and propylene), copolymers of VDF and HFP as well as homopolymers or copolymers comprising other fluorinated olefins or vinyl ethers. These polymers are described in detail in “Modern Fluoropolymers” cited above.

The work up procedure as disclosed in U.S. Pat. No. 5,463,021 describes inter alia, a treatment of THV raw dispersions via an ion exchange process as one work up step. However, this is a cationic exchange process to remove the manganese ions originated from the permanganate used as polymerization initiator. During the cationic exchange process the stabilizing electrical double layer is not affected because the latex particles are anionically stabilized.

The fluoropolymer dispersions produced with the process of the invention can be used in any coating application in which fluoropolymers have been used. In particular, the fluoropolymer dispersions produced with the process of this invention can be used to coat continuous, woven or non-woven substrates, e.g., the dispersions can be used to coat metal, such as cookware or bakeware, fabrics, in particular glass fabrics, and to coat chemical apparatus.

Also, substrates requiring lower temperature processing may be coated. These include, for example, sheets or fibers of polyvinyl chloride, polyurethane, polyethylene terephthalate, rubbers and polyolefins. Substrates able to withstand high temperatures may also be coated such as ceramic, aramids, imides, fluoropolymers and polybenzyl imidazole.

Coating methods which are useful include dip coating, slide coating, curtain coating, knife coating, roll coating and slot coating. Spray coating may also be used and may be useful for anti-dusting purposes, such as the spraying of PTFE dispersions onto clay particles to control dusting. Such materials are commonly used to absorb waste products from household pets, as in a cat litter box. Such applications would not normally require sintering.

The fluoropolymer dispersions can also be used to form films and shaped articles.

The invention is illustrated by the following examples.

Experimental Details:

All percentages are by weight unless otherwise stated.

Determination of PFOA

The PFOA content of the anion exchanged dispersion may be quantitatively analyzed by using the method described in “Encyclopedia of Industrial Chemistry Analysis”, Vol. 1, pages 339 to 340, Interscience Publishers, New York, N.Y., 1971 and in EP-A 194 690. Another method used is the conversion of the PFOA to its methyl ester and analyzing the ester content by gas chromatography using an internal standard. The detection limit for PFOA for the latter method is 5 ppm. The latter method was used in the following examples.

Anion Exchange

Standard equipment was used. The dimensions of the column were 5×50 cm. AMBERLITE™ IRA 402 with a capacity of 1.2 meq/ml as strong basic anion exchange resin was used (AMBERLITE is a Trademark of Rohm & Haas). The bed volume was usually 400 ml. The ion exchanger was brought into the OH⁻ form with NaOH solution. The exchanger was preconditioned with a 5%-solution of the non ionic emulsifier. The ion exchange was carried out at room temperature. The experiments were performed at different flow rates as given in Table 1. The non ionic emulsifier was added as a 10% concentrated solution to the dispersions. The content was varied as given in Table 1. The values are based on the polymer content. The technical feasibility of this process is considered to be accomplished if at least 5% of the theoretical capacity of the ion exchange resin supplied is consumed by the PFOA containing dispersion without jamming the bed and without break through of PFOA.

The Nonionic Surfactants Applied are:

NIS 1: octyl phenoxy polyethoxy ethanol (commercial product TRITON™ X 100, TRITON is a Trademark of Union Carbide Corp.).

NIS 2: ethoxylate of a long-chain alkanol (commercial product GENAPOL™ X 080, GENAPOL is a Trademark of Hoechst AG).

### EXAMPLES 1 to 7

All experiments were carried out with AMBERLITE IRA 402 in the OH⁻ form. Preconditioning of the anion exchange resin with an aqueous solution of the non ionic surfactant was changed as indicated in Table 1.

The fluoropolymer dispersion was obtained by homo-polymerization of TFE according to EP-B 30 663. The solid content of the raw dispersion used is about 20%, and the average particle size is about 200 to 240 nm. The pH value is 7. The amount and the type of the non ionic emulsifier added to the raw dispersion was changed as indicated in Table 1.

The PFOA content of the dispersion is about 0.13 weight-% (amounting to 3.14 mmol/kg dispersion). This corresponds to 2.7 ml of ion exchange resin per kg of raw dispersion. Example 3 shows that 54 ml of the total volume of 400 ml ion exchange resin are used. Thus, the provided ion exchange capacity was more than 5 times in excess for all examples.

The experimental details in Table 1 show different flow rates. During a given experiment no changes in the flow rate were observed. This is an indication of the absence of jamming of the ion exchange bed. The run time of the experiments was up to 67 h without interruption. All the examples result in dispersions with PFOA contents of less than 5 ppm, the analytical detection limit of the method used.

TABLE 1

| Example No. | 1 | 2 | 3 | 4 | 5 | 6 | 7 |
|---|---|---|---|---|---|---|---|
| Ion exchange | 400 ml | 400 ml | 400 ml | 4 parallel | 4 parallel | 400 ml | 400 ml |
| resin, ml | | | | columns | columns | | |
| | | | | 400 ml each | 400 ml each | | |
| Ion exchange | 1 weight-% | 5 weight-% | 3 weight-% | 5 weight-% | 5 weight-% | 5 weight-% | 1 weight-% |
| resin conditioned | NIS 1 | NIS 1 | NIS 1 | NIS 1 | NIS 2 | NIS 2 | NIS 2 |
| with an aqueous | | | | | | | |
| solution of | | | | | | | |
| Raw dispersion: | | | | | | | |
| Solid content of | 22.7% | 22.6% | 22.7% | 22.7% | 22.5% | 23% | 22.8% |
| PFOA content | 0.132% | 0.130% | 0.132% | 0.136% | 0.138% | 0.138% | 0.136% |
| Raw dispersion | | | | | | | |
| Stabilized with | 1% NIS 1 | 3% NIS 1 | 4% NIS 1 | 5% NIS 1 | 5% NIS 2 | 4% NIS 2 | 1% NIS 2 |
| *) | | | | | | | |
| Amount passed | 5 kg | 19 kg | 20 kg | 40 kg | 50 kg | 18 kg | 8 kg |
| Through | | | | | | | |
| Flow rate | 0.5 1/h | 0.6 1/h | 0.3 1/h | 0.6 1/h | 0.6 1/h | 0.6 1/h | 0.5 1/h |
| Runtime | 10 h | 35 h | 67 h | 17 h | 21 h | 30 h | 16 h |
| Jamming yes/no | no | no | no | no | no | no | no |
| Ion exchanged | | | | | | | |
| dispersion | | | | | | | |
| PFOA content | <5 ppm | <5 ppm | <5 ppm | <5 ppm | <5 ppm | <5 ppm | <5 ppm |

*) based on solid content of the dispersion

### EXAMPLE 8

800 ml of AMBERLITE IRA 402 (OH⁻ form, preconditioned with a 5%-solution of NIS 1) was slowly added to a stirred vessel containing 20 liters of dispersion similar to that used in examples 1 to 7, but upconcentrated by ultrafiltration (solid content: 52.5%, PFOA content: 0.065%, NIS 1 content: 5% based on polymer content). After mild stirring for 8 h at room temperature the anion exchanger was filtered off and the PFOA content of the dispersion was analyzed resulting in less than 5 ppm PFOA.

### EXAMPLE 9

The same procedure as for examples 1 to 7 was used for purification of a PFA raw dispersion. 400 ml of AMBERLITE IRA 402 (OH⁻ form, preconditioned with 1%-solution of NIS 2) were used. The PFA dispersion (1500 ml, solid content 20%) was stabilized with 5 weight-% of NIS 2 based on the solid content of the dispersion. This dispersion contained 0.066 weight-% of PFOA and showed a pH value of 4. The dispersion was passed over the anion exchanger bed with a flow rate of 100 ml/h. This corresponds to a run time of 15 h. No jamming of the bed was observed and the resulting dispersion showed a PFOA content of <5 ppm.

### EXAMPLE 10

Example 9 was repeated using a FEP raw dispersion (solid content 20 weight-%, PFOA content 0.08 weight-%) stabilized with 5 weight-% of NIS 2. The ion exchange process resulted in a FEP dispersion containing <5 ppm of PFOA. No jamming of the bed was observed.

### EXAMPLE 11

Example 9 was repeated but with a THV dispersion having a solid content of 20% and a average particle size of 80 nm. Before subjecting the dispersion to the anion exchange it was treated with a cation exchange resin as described in U.S. Pat. No. 5,463,021. The anion exchange process resulted in a THV dispersion containing <5 ppm of PFOA and no jamming of the bed was observed.

### EXAMPLE 12 AND COMPARATIVE EXAMPLE C1

In Example 12 and Comparative Example C1, samples of glass cloth were coated using PTFE dispersions with reduced PFOA content (example 12) and PTFE dispersions that had not been treated to reduce PFOA content (Comp. Ex. C1). The dispersions for Example 12 were prepared in a manner similar to the process described in Example 2. Starting PTFE dispersions included TFX 5060 and TFX 5065, available from Dyneon LLC, Oakdale, Minn. The glass cloth was a standard industrial fabric with the international code US 116 from CS-Interglas, with a nominal weight of 110 gram/sq meter, yarn in warp and in weft are EC 5-11×2. The dispersions were applied in 5 passes. The first pass dispersion for Example 12 was TFX 5060 with reduced APFO content as described above and diluted to 50% solids, applied by dip coating. The wet coating thickness was adjusted using a doctor blade. The coated fabric was subjected to drying and sintering in three steps after each pass. The heat was supplied by infrared heaters. The first zone was 80±20° C., the second zone was 270±20° C. and the third zone was 375±20° C. The speed through the dryer was 0.3 meters/minute. The weight of the coating added to the fabric was measured to be 24.5% of the total fabric+coating weight.

The second pass through the coater for Example 12 used the same dispersion except at approximately 60% solids by weight. This was applied on top of the first pass coating. After drying and sintering the total coating weight was approximately 45.7% of the total fabric and coating weight. The 3^{rd}, 4^{th} and 5^{th} coating passes were done in a similar manner except the dispersion used was TFX 5065 treated to reduce the APFO content as discussed above for TFX 5060. The solids content for each of pass 3, 4 and 5 was 59%. The weight of the coating on the fabric after the third, fourth and fifth passes was 55.2 wt %, 57.8 wt % and 62.1 wt % respectively.

The coating of the glass cloth for Comparative Example Cl was done in a manner similar to that described for Example 12 except the dispersions used were not treated to reduce the PFOA content.

Test results of adhesion strength, abrasion and surface gloss @ 20° for Example 12 and Comparative Example C1 were similar to each other.

### EXAMPLE 13 and COMPARATIVE EXAMPLE C2

In Example 13 and Comparative Example C2, aluminum panels coated with PTFE dispersion were prepared using Type A smooth mill finish 3105H24 aluminum panels (available from Q-Panels Lab Products, Cleveland, Ohio) and PTFE dispersions with and without a reduced APFO content. The dispersion for Example 13 was prepared in a manner similar to Example 12 except the starting material was TF 5035, available from Dyneon LLC, instead of TFX 5060 or TFX 5065 used in Example 12. The dispersion used for Comparative Example C2 was the TF 5035 dispersion without treating it to reduce the APFO level.

The aluminum panels (approximately 7.5 cm×15 cm×0.0635 m thick) were prepared by roughening one surface with 120 grit sand paper. The coating was applied using a Maxum II HVLP spray gun Model NBC #3 with a large spray pattern at 10 psi air pressure and a material flow setting of “less fluid.”

The roughened aluminum panels were heated before coating by preheating a ¼″ steel plate to 400° C. on a Wabash heated platen press, leaving approximately ¼″ (0.635 cm) air gap between plate and upper platen. The heated steel plate was moved to a plastic lined fume hood, and set on a large metal block. Four aluminum panels (roughened side facing up) were set on the heated steel plate. The dispersion was then sprayed, with the spray gun trigger fully depressed, making 2 spraying passes over each panel, approximately 8 inches (20 cm) above the aluminum surface. The panels were allowed to set until all visible liquids were driven off. The steel plate with the panels was then moved back to the heated Wabash press (400° C.), with approximately a ¼″ (0.635 cm) gap between the coated surface of the aluminum panels and upper platen for a period of 10 minutes. The plate and coated panels were then removed to a fume hood to cool for approximately 15 minutes. Each dispersion was coated in a similar manner.

The advancing and receding contact angles were determined using a Rame-Hart goniometer fitted with an overhead syringe mount for applying a liquid to the test specimen with a needle and a syringe. The syringe allows a drop to be placed upon the sample while it is being observed through the microscope. The liquid can be advanced over the surface and pulled back from the surface to obtain advancing and receding contact angles. Both water and hexadecane were used. At least three advancing and three receding measurements are made on each specimen. The average advancing and receding contact angles measured with hexadecane on both samples are similar and the contact angles measured using water are slightly higher for the sample with the APFO removed.

### EXAMPLE 14 AND COMPARATIVE EXAMPLE C3

In Example 14 and Comparative Example C3 aluminum panels were coated and evaluated in a manner similar to Example 13 and Comparative Example C2 except the dispersions were applied over a primer coat. The primer contained a polyamide imide (PAI) binder and PTFE dispersion and was prepared as follows.

A PAI solution was prepared in a 1 liter flask by adding 358.3 g of 99.5% 1-methyl-2-pyrrolidinone (NMP) to the flask. Then, 145 g of BP Amoco AI10 polymer (PAI) (29% wt) was added slowly (over thirty minutes) to the NMP. The resulting mixture was stirred for 2 hours. A 5.8% solution was prepared by diluting 50.3 g of the PAI solution with an additional 200 g of NMP. To this 5.8% solution was added 25 g of the respective PTFE dispersion with stirring yielding a solution with a 1:1 ratio of PAI:PTFE. Example 14 used a dispersion of TF 5035 from which the APFO had been removed and Comparative Example C3 used the TF5035 without removal of the APFO.

Panels of aluminum were prepared and sprayed with each above dispersion and binder mixture in a manner similar to that described in Example 13 except the panels in this example were wiped with acetone after roughening and the panels were not preheated prior to coating. After coating, the panels were air dried at room temperature (about 22° C.) for 15 minutes, then cured at 260° C. for 15 minutes in the Wabash heated platen press with approximately a ½ inch (1.25 cm) gap between the platens.

Immediately after the cure of the primer layer, a topcoat of, respectively, TF 5035 with APFO removed (Example 14) or TF 5035 (Comparative Example C2) was applied using the same sprayer settings. The coated panels were allowed to dry for about 15 hours at room temperature (about 22° C.) and then cured in the ½ inch (1.25 cm) gap of the platen press at 400° C. for 10 minutes.

No significant differences were noted in the coating of the panels or the properties of the finished coatings.

### EXAMPLE 15 AND COMPARATIVE EXAMPLE C4

In Example 15 and Comparative Example C4, aluminum panels were prepared, coated and evaluated in a manner similar to Examples 14 and Comparative Example C3 except that the PAI in the first coat or primer layer in each was replaced with XYLAN™ 8254 Dark Grey Primer (MOD) available from Whitford Corp., West Chester, Pa. The spray gun pressure was set at 18 psi for each primer coat and 10 psi for each top coat. After curing each first coating, the panels were cooled to room temperature (20-22° C.). After cooling, the coated panels were stored in polybags to prevent contamination. The respective top coats were applied as in Example 14 (dispersion with reduced APFO content) and Comparative Example C3 (TF 5035).

The top coat adhesion was improved with the samples containing the XYLAN primer when compared to either the PAI containing dispersion or the coatings without primers. The adhesion was determined using a tape test (ASTM D-3359-97 method B). No difference was seen when comparing the TF 5035 coating (Comparative Example C4) to the one with reduced APFO content (Example 15).

### EXAMPLES 16 AND 17

In Examples 16 and 17, an anion-exchange column with a resin bed of 400 ml was used to determine the removal behavior of perfluorocarbon acids with different chain lengths. The experiments were carried out with the strong basic anion exchange resin AMBERLITE IRA 402 (Trademark of Rohm & Haas). The exchanger was brought into the OH⁻ form with NaOH solution.

### EXAMPLE 16

A mixture of perfluorocarbon acids was passed over the anion exchanger with a continuous flow rate of 400 ml/h. The pH of the aqueous solution was set to 2-4. The aqueous solution contained 0.1 weight-% in total of the of the different perfluorocarbon acids. After anion exchange, the residual concentrations of all acids were smaller than 5 ppm as shown in Table 2.

TABLE 2
Residual perfluorocarbon acid concentration

| Composition | | Acid₁ | Acid₂ | Acid₃ | Acid₄ |
|---|---|---|---|---|---|
| Initial concentration | % (m/m) | 1.5 | 6.2 | 90.0 | 2.3 |
| Residual concentration | ppm | <5 | <5 | <5 | <5 |
| after anion exchange | | | | | |

Acid₁ CF₃—(CF₂)₄—COOH
Acid₂ CF₃—(CF₂)₅—COOH
Acid₃ CF₃—(CF₂)₆—COOH
Acid₄ CF₃—(CF₂)₈—COOH

### EXAMPLE 17

A different mixture of perfluorocarbon acids was passed over the anion exchanger with a continuous flow rate of 200 ml/h. The pH of the aqueous solution was set to 2-4. The aqueous solution contained 0.09 weight-% in total of the of the different perfluorocarbon acids. The residual concentration of all acids were smaller than 5 ppm after the anion exchange as shown in Table 3.

TABLE 3
Residual perfluorocarbon acid concentration

| Composition | | Acid₁ | Acid₂ | Acid₃ |
|---|---|---|---|---|
| Initial concentration | % (m/m) | 32 | 56 | 12 |
| Residual concentration | ppm | <5 | <5 | <5 |
| after anion exchange | | | | |

Acid₁ CF₃—(CF₂)₆—COOH
Acid₂ CF₃—(CF₂)₇—COOH
Acid₃ CF₃—(CF₂)₉—COOH

The results in Tables 2 and 3 demonstrate that perfluorocarbon acids of different chain lengths are efficiently removed via the described procedure.

### EXAMPLE 18 AND COMPARATIVE EXAMPLE C5

In Example 18 and Comparative Example C5, aluminum panels were prepared and evaluated in a manner similar to Example 14 and Comparative Example C3, respectively, except the primer solutions were changed. The primer solutions for Example 18 and Comparative Example C5 further contained a PFA fluoropolymer and were prepared as follows: For Comparative Example C5, an NMP solution containing 29 wt. % of PAI was made and allowed to sit overnight. A 60 g portion of the 29wt % solution was further diluted with 61.8 g of NMP to reduce viscosity. To this reduced viscosity solution was added 30 grams of TF 5035 PTFE (in a 55% solids aqueous dispersion) with stirring. An additional 34.8 g of NMP was added to the resulting composition. Then, 34.46 g of PFA 6900N fluoropolymer (in a 50.5% solids dispersion), available from Dyneon LLC, was added with stirring. A final 69.6 g of NMP was then added.

The primer composition for Example 18 was prepared in a similar manner except the TF 5035 PTFE and the PFA 6900N were both treated to reduce the APFO content as described above in Example 2.

The topcoat for Example 18 was the TF 5035 PTFE dispersion treated to reduce the APFO content and the topcoat for Comparative Example C5 was the TF 5035 PTFE dispersion without any treatment to reduce APFO content. After curing of the topcoats, the adhesion was evaluated using ASTM D-3359-97 Method B. Both samples had an evaluation rating of 3B using Scotch Pad high performance packaging tape pads, transparent type 3750-P, available from 3M Co., St. Paul, Minn. No difference was seen when comparing the TF 5035 coating over the PFA-containing primer (Comparative Example CS) to the one with the reduced APFO content TF 5035 over the reduced APFO content PFA-containing primer (Example 18).

1. Aqueous fluoropolymer dispersion, being essentially free of fluorine-containing emulsifier.

2. Dispersion according to claim 1, containing less than 100 ppm of fluorine-containing emulsifier.

3. Dispersion according to claim 1, wherein the fluoropolymer is a polymer of tetrafluoroethylene.

4. Dispersion according to claim 3, wherein the polymer contains at least one monomer selected from the group consisting of fluorinated olefins of 2 to 8 carbon atoms, fluorinated alkyl vinyl ethers and fluorinated alkoxy vinyl ethers with an alkyl of 1 to 6 carbon atoms.

5. Dispersion according to claim 4, wherein the fluorinated olefin and the alkyl vinyl ether are each perfluorinated.

6. Dispersion according to claim 4, wherein the fluorinated olefin is selected from hexafluoropropene and vinylidene fluoride.

7. Dispersion according to claim 5, wherein the alkyl vinyl ether is selected from perfluoro-(n-propyl-vinyl) ether and perfluoro-(methyl-vinyl) ether.

8. Dispersion according to claim 3, wherein the polymer contains 90 to 100 mol % tetrafluoroethylene.

9. Dispersion according to claim 1, wherein the fluoropolymer comprises one or more fluorinated monomers, with the proviso that none of the monomers are tetrafluoroethylene.

10. A process for removing fluorine-containing emulsifier from an aqueous fluoropolymer dispersion which comprises adding to the dispersion an effective amount of a nonionic emulsifier to stabilize the dispersion, contacting this stabilized dispersion with an effective amount of an anion exchange resin to essentially remove fluorine-containing emulsifier from the stabilized dispersion and separating the dispersion from the anion exchange resin and optionally, subjecting the so-obtained dispersion to upconcentration.

11. The process as claimed in claim 10, wherein the solids content of the said dispersion is 10 to 70 weight-%.

12. The process as claimed in claim 10, wherein the stabilized dispersion is contacted with the anion exchange resin in a basic environment.

13. The process as claimed in claim 10, wherein from 0.5 to 15% by weight of nonionic emulsifier is added, based on the weight of the solids content of the dispersion.

14. The process as claimed in claim 10, wherein the anion exchange resin has a counterion corresponding to an acid with a pKa value of at least 3.

15. The process as claimed in claim 10, wherein the anion exchange resin is used in the hydroxyl form.

16. An article prepared with an aqueous fluoropolymer dispersion according to claim 1.

17. An article comprising an aqueous fluoropolymer dispersion prepared according to claim 10.

18. An article comprising a coating of an aqueous fluoropolymer dispersion according to claim 1.

19. An article comprising a coating of an aqueous fluoropolymer dispersion prepared according to claim 10.

20. An article according to claim 17 comprising a fabric.

21. An article according to claim 17 wherein the article is metal.
